(19) United States
(12) Patent Application Publication
(10) Pub. No.: US 2016/0335279 A1
(43) Pub. Date: Nov. 17, 2016

(54) METHOD FOR LOADING WEBSITE COMMENTING INFORMATION, AND BROWSER CLIENT

(71) Applicant: BEIJING QIHOO TECHNOLOGY COMPANY LIMITED, Beijing (CN)

(72) Inventors: Xinchao TIAN, Beijing (CN); Yuanzhen MA, Beijing (CN)

(21) Appl. No.: 15/110,244

(22) PCT Filed: Dec. 31, 2014
(86) PCT No.: PCT/CN2014/095962

§ 371 Date: Jul. 7, 2016

(30) Foreign Application Priority Data
Jan. 8, 2014 (CN) 201410009251.6

(51) Int. Cl. G06F 17/30; G06F 17/24; G06F 3/0481; G06F 3/0484; G06Q 30/02; H04L 29/06

(52) U.S. Cl. CPC G06F 17/3089; G06F 17/30867; G06F 17/30707; G06Q 30/0282; H04L 63/20; G06F 17/30716; G06F 3/0481; G06F 3/04842; G06F 3/04817; G06F 3/04847; G06F 17/241

(57) ABSTRACT

A method for loading website commenting information, and a browser client, which belong to the technical field of communications. The method comprises: acquiring website information corresponding to a currently loaded webpage; acquiring first commenting data corresponding to the website information from a server side in accordance with the website information about the currently loaded webpage; and starting a first commenting window at a browser side, and loading and displaying the first commenting data in the first commenting window. By means of the implementation of the present invention, a user can acquire, in real time, commenting information about a currently loaded webpage via a first commenting window and effectively judge in time whether the current webpage is available in accordance with the commenting information, thereby saving a lot of precious time for the user and greatly increasing the usage efficiency of the user.

### CROSS-REFERENCE TO RELATED APPLICATIONS

This application is the national stage of International Application No. PCT/CN2014/095962 filed Dec. 31, 2014, which is based upon and claims priority to Chinese Patent Application No. CN201410009251.6, filed Jan. 8, 2014, the entire contents of which are incorporated herein by reference.

### FIELD OF TECHNOLOGY

The present disclosure relates to the technical field of communications and, more particularly, to a method for loading website commenting information, and a browser client.

### BACKGROUND

At present, network becomes a necessary part of human in daily life, such as in shopping, information query, making friends with network, playing games, equipment trading, etc.

However, the quantity of websites providing data service is enormous, the qualities of contents are various and different, it is difficult for a user to find out suitable websites if he or she does not know the website contents. The user is not able to acquire the quality of the website content even if the user uses a searching engine to search, since the acquired results are frequently up to millions. This is a great waste of time, and the user's efficiency is seriously affected.

### SUMMARY

In view of the problems mentioned-above, the present disclosure discloses a method for loading website commenting information, and a browser client, in order to overcome or at least solve part of the above-mentioned problems.

According to an aspect of the present disclosure, there is disclosed a method for loading website commenting information, comprising: acquiring website address information corresponding to a currently loaded webpage; acquiring first commenting data corresponding to the website address information from a server side according to the website address information of the currently loaded webpage; and starting a first commenting window at a browser side, and loading and displaying the first commenting data in the first commenting window.

According to another aspect of the present disclosure, there is disclosed a browser client, comprising: a processor, configured to: acquiring website address information corresponding to a currently loaded webpage; acquiring first commenting data corresponding to the website address information from a server side according to the website address information acquired by the website address acquiring module; and starting a first commenting window, and loading and displaying the first commenting data acquired by a first commenting data acquiring module in the first commenting window.

According to still another aspect of the present disclosure, there is disclosed computer program, comprising computer readable codes, wherein when the computer readable codes are carried out on a browser client, the browser client executes the method for loading webpage commenting information above.

According to still another aspect of the present disclosure, there is disclosed a computer readable medium, in which the computer program above is stored.

The beneficial effect of the present disclosure lies in that:

In the conventional technology, when a user uses the browser to open a webpage, he or she may not effectively judge the quality of the website content in time, and he or she may only judge the effectiveness of the webpage content after he or she views the webpage content and utilizes the functions that the webpage supplies. In this way, a lot of time is spend, which seriously reduces using efficiency. In the present disclosure, the first commenting data corresponding to the currently loaded webpage is acquired from the server side, and the first commenting data is loaded and displayed in the first commenting window, the user may acquire commenting information of a currently loaded webpage in real time via a first commenting window and effectively determine whether the current webpage is available according to the commenting information in time, thereby saving a lot of precious time for the user and greatly increasing the usage efficiency of the user.

Described above is merely an overview of the inventive scheme. In order to more apparently understand the technical means of the disclosure to implement according to the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 is a flow chart showing the step of the method for loading website commenting information according to an embodiment of the invention.

FIG. 2 is a flow chart showing the step of the method for loading website commenting information according to an embodiment of the invention.

FIG. 3 is a flow chart showing the step of the method for loading website commenting information according to an embodiment of the invention.

FIG. 4 is a schematic diagram showing the structure of the browser client according to an embodiment of the invention.

FIG. 5 is a block diagram of a computing device for executing the method according the disclosure; and

FIG. 6 is a schematic diagram of a memory cell which is used to store or carry program codes for realizing the methods according to the disclosure.

### DESCRIPTION OF THE EMBODIMENTS

Hereinafter, the present disclosure is further described in accompanying with figures and embodiments.

### Embodiment 1

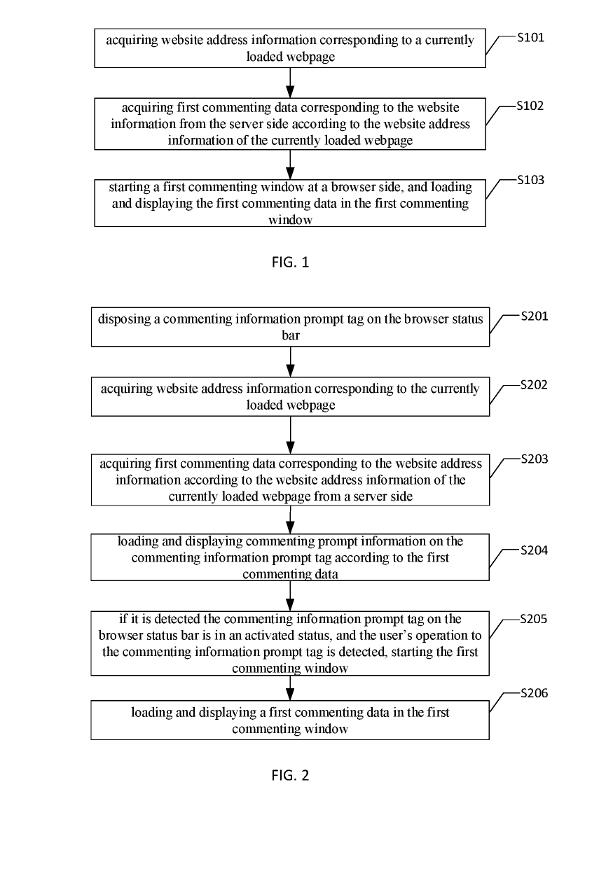

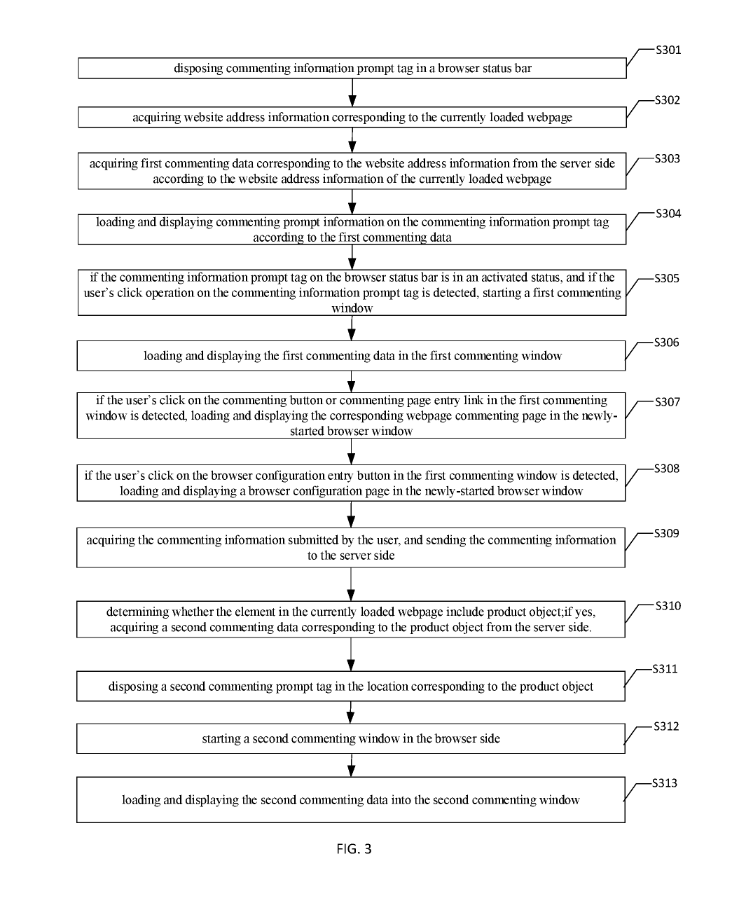

Referring to FIG. 1, it shows a method for loading website commenting information according to an embodiment of the invention, which includes:

S101, acquiring website address information corresponding to a currently loaded webpage.

The website address information concretely includes Uniform Resource Locator (URL) of the currently loaded webpage. Furthermore, the website information further includes the host data extracted from the URL. For example, the currently loaded webpage URL is http://www.abc.com/news/123.html, then the host is abc.com.

S102, acquiring first commenting data corresponding to the website information from the server side according to the website address information of the currently loaded webpage.

The server side pre-stores the first commenting data corresponding to the website address information.

Specifically, the browser client may collect user's commenting information to the website through a website commenting entry, such as impression on the website, marks website grade (worse, bad, better, good, best), as well as the website's good-commenting rate obtained according to the users' good-commenting quantity and the total-commenting quantity, etc.; then the server stores the collected commenting information as first commenting data.

It should be noted that, the first commenting data pre-stored by the server side may be website commenting information submitted by the user from the browser via the website commenting entry by the above means, they may also be commenting information from other commenting websites via a third party's data interface, which is not limited in the present disclosure.

S103, starting a first commenting window at a browser side, and loading and displaying the first commenting data in the first commenting window.

In the embodiment of the present disclosure, the first commenting data acquired from the server side may specifically include: a host computer name, and/or good-commenting rate, and/or total-commenting quantity, and/or exposure quantity, and/or good-commenting quantity, and/or mid-commenting quantity, and/or bad-commenting quantity, and/or impression keyword, and/or impression quantity. Obvious, a skilled person in the art should understand that, it is capable to determine the concrete contents of the first commenting data and load and display the content of the first commenting data in the first commenting window according to specific demands while implementing the invention.

If the matched first commenting data are acquired from the server side, it is capable to start the first commenting window in the server side, and load and display the first commenting data. Wherein the first commenting window may be a new browser window, or a floating window created in the current webpage. The first commenting window may be triggered by the browser to start after acquiring the first commenting data. Otherwise, it may also be triggered according to the user's instruction to start. For example, the user clicks a commenting information prompt tag/button disposed in a browser tool bar, menu bar or state bar and starts the corresponding first commenting window. In the embodiment of the disclosure, the shape, style and triggering mode of the first commenting window are not limited.

In the conventional technology, when the user opens a webpage with a browser, he or she may is not capable to effectively judge the quality of the website content in time, and he or she may only judge the effectiveness of the webpage content after he or she views the webpage content and utilizes the functions that the webpage supplies. In this way, a lot of time is spend, which seriously reduces using efficiency. In the present disclosure, the first commenting data corresponding to the currently loaded webpage is acquired from the server side, and the first commenting data are loaded and displayed in the first commenting window, the user may acquire commenting information of the currently loaded webpage in real time via a first commenting window and effectively determine whether the current webpage is available according to the commenting information in time, thereby saving a lot of precious time for the user and greatly increasing the usage efficiency of the user.

In another embodiment of the invention, acquiring the first commenting data corresponding to the website address information from a server side, specially comprises:

disposing security query interface at the browser side;

sending security query requesting information to the server side via the security query interface, the security query requesting information carries website address information of the currently loaded webpage and first commenting query requesting information; and

receiving security query result information from the server side, the security query result information carrying the first commenting data.

During implementing the invention, the skilled person in the art may organize the security query result information format and/or the first commenting data format fed back from the server side according to specific demands. Hereinbelow, a specific example is used to describe the process of acquiring security query result information carrying the first commenting data.

The website address information of the currently loaded webpage is: http://www.abc.com/news/123.html, wherein the host is abc.com;

The browser side sends security query requesting to the server side via the security query interface, and the feeds back security query result information carrying the first commenting data, which may be as follows:

{ security.info {good:100}{bad:1}}

{dianping.info:{h:abc.com}{c:18157}{e:11}{gs:86}{s1:15144}{s2:618}{s3:2395}{i1:4}{
i2: very cheap_6287||bad quality_16|| good after-sale service_5198|| paid after goods
received_3837}}

Wherein, field security.info is the security query result information; field dianping.info the first commenting data field. The meanings of each field in the data segment are followings:

// h: hostname
//c: total-commenting quantity
//e: exposure quantity
//s1: good-commenting quantity
//s2: mid-commenting quantity
//s3: bad-commenting quantity
//gs: best-commenting quantity
//i1: impression quantity
//i2: impression word (format xxx_xxx_xxxx)

The security query result information returned from a server side reflects the security of the currently loaded webpage, which avoids a user from accessing unsafe webpage. In the embodiment of the disclosure, by carrying first commenting query requesting information in security query requesting information sent to the server side, and by receiving returned first commenting data via the security query interface; the security restriction of the currently loaded webpage is realized and the corresponding first commenting data are also acquired by only once query request, which effectively reduces demands for the resources of the server side and reduces the reacting time of the browser side, allowing the user to obtain security information and commenting information of the currently loaded webpage fast, thereby greatly increasing the usage efficiency of the user.

Obviously, a skilled person in the art easily understands that, it is an preferred way to acquire a first commenting data from a server side via the security query interface; while implementing the invention, a skilled person in the art may directly send commenting data query request to the server side, and receive commenting data dianping.info. returned from the server side.

In another preferred embodiment of the disclosure, the first commenting window is disposed with a commenting button and/or commenting page entry link;

the method of loading the website commenting information further comprises:

if a user's clicking the commenting button or commenting page entry link in the first commenting window is detected, it is capable to load and display corresponding website commenting page in a newly-started browser window; the website commenting page comprises: user's impression keywords and corresponding impression quantity, user's commenting history information, a commenting information input frame and a corresponding commenting information submitting button;

acquiring the commenting information submitted by the user;

sending the commenting information to a server side, and storing the commenting information as a first commenting data corresponding to the website address information of the currently loaded webpage.

In the embodiment, a commenting page entry at a browser side is provided to a user, displaying detailed commenting information such as user's commenting history information and user's impression keywords corresponding to the currently loaded webpage via the website commenting page in the browser window, generating first commenting data by collecting multiple pieces of commenting information submitted by the user, and acquiring good-commenting rate according to a plurality of collected good-commenting information and the total-commenting quantity. This objectively reflects usefulness of the currently loaded webpage, so that the user may determine whether to continue using the currently loaded webpage fast.

Furthermore, by disposing commenting button and/or commenting page entry link in the first commenting window, a user may acquire the commenting page entry position at the first time, by clicking the commenting button and/or commenting page entry link, it is capable to directly jump to the website commenting page window, and view the detailed commenting information in the window, and complete commenting information submission in the window, saving the user's time spend for searching for a commenting page entry.

In another preferred embodiment of the disclosure, in the first commenting window is further disposed with a browser configuration entry button;

the method further includes:

if a user's clicking the a browser configuration entry button is detected, it is capable to load a browser configuration page in the newly-started browser window; the browser configuration page including a commenting starting button;

receiving a browser configuration information submitted by the user, the browser configuration information including a commenting start identification.

In the conventional technology, a browser configuration entry button is usually disposed in the menu bar of the browser. The user needs many times spread the browser menu and search for the button's location when he or she locates the browser configuration entry button in the menu bar because the menu has a multi-layer tree structure, the process is both trivial and time-wasting. In the embodiment, by disposing a browser configuration entry button in a first commenting window, and after a user clicking the configuration entry button, the operating window for starting/closing the website commenting function is directly shown in the user's current window, which is convenient for the user to determine whether starting the first commenting window, saving the user's time to spend for searching and locating configuration entry button in the menu bar.

### The Second Embodiment

S201, disposing a commenting information prompt tag on the browser status bar;

wherein, commenting prompt information is loaded and displayed in the commenting information prompt tag, the commenting prompt information comprises: good-commenting rate and corresponding commenting icon.

S202, acquiring website address information corresponding to the currently loaded webpage.

S203, acquiring first commenting data corresponding to the website address information according to the website address information of the currently loaded webpage from a server side.

S204, loading and displaying commenting prompt information on the commenting information prompt tag according to the first commenting data, the commenting prompt information comprising: good-commenting rate and corresponding commenting icon;

Furthermore, if the first commenting data acquired from a server side are invalid data, the commenting information prompt tag on the server side status bar is set in inactivated status with gray color; if the acquired first commenting data are valid data, the commenting information prompt tag on the server side status bar is set in activated status, and the good-commenting rate and corresponding commenting icons are loaded in the tag.

When a server side does not match with the first commenting data corresponding to the website address information of the currently loaded webpage, it is capable to return invalid first commenting data or vacant data, and the browser side determines whether the received first commenting data is valid; if invalid, the commenting information prompt tag is set in inactivated status with gray color;

S205, if it is detected the commenting information prompt tag on the browser status bar is in an activated status, and the user's operation to the commenting information prompt tag is detected, starting the first commenting window.

S206, loading and displaying a first commenting data in the first commenting window.

### The Third Embodiment

S301, disposing commenting information prompt tag in a browser status bar.

S302, acquiring website address information corresponding to the currently loaded webpage.

S303, acquiring first commenting data corresponding to the website address information from the server side according to the website address information of the currently loaded webpage.

S304, loading and displaying commenting prompt information on the commenting information prompt tag according to the first commenting data, the commenting prompt information comprises: good-commenting rate and corresponding commenting icon.

S305, if the commenting information prompt tag on the browser status bar is in an activated status, and if the user's click operation on the commenting information prompt tag is detected, starting a first commenting window.

S306, loading and displaying the first commenting data in the first commenting window.

Wherein, in the first commenting window is disposed with a commenting button and/or a commenting page entry link, and/or a browser configuration entry button.

S307, if the user's click on the commenting button or commenting page entry link in the first commenting window is detected, loading and displaying the corresponding webpage commenting page in the newly-started browser window.

S308, if the user's click on the browser configuration entry button in the first commenting window is detected, loading and displaying a browser configuration page in the newly-started browser window.

The user may set whether the browser starts the commenting in the browser configuration page in the new window.

S309, acquiring the commenting information submitted by the user, and sending the commenting information to the server side.

The server side stores the commenting information from the browser side as first commenting data corresponding to the website address information.

S310, determining whether the element in the currently loaded webpage include product object; if yes, acquiring a second commenting data corresponding to the product object from the server side.

Wherein, the product object includes any product, commercial goods or service with a certain form, such as articles for daily use, electronic products, food, books, movies, hotels, restaurants, tourist attractions, etc. Second commenting data corresponding to the product object specifically includes: commenting data resource information, and corresponding product grade information, and/or product advantage information, and/or product disadvantages information, and/or product evaluating link.

In the embodiment, second commenting data may be the product object commenting information submitted by the user via the browser collected through the website commenting entry, and may also be acquired from commenting information from other commenting websites via a third party data interface, which is not specifically limited. Preferably, the second commenting data may be from the website of Zhongguancun online (www.zol.com.cn) and the website of Dianping (www.dianping.com).

S311, disposing a second commenting prompt tag in the location corresponding to the product object.

Wherein, the second commenting prompt tag may be disposed below the location of the product object in the webpage, as well as may be disposed in other locations, such as in a browser status bar, etc. The disclosure does not limit the location of the second commenting prompt tag.

Furthermore, it is capable to determine whether second commenting data are valid; if yes, it is capable to dispose an activated status in the second commenting prompt tag, load and display commenting information corresponding to the product object such as product grade information in the second commenting prompt tag; if the second commenting data are invalid or vacant data, the second commenting prompt information is disposed as an inactivated status in gray color.

S312, starting a second commenting window in the browser side.

If the second commenting data are valid, or the second commenting prompt tag is in an activated status, and a user's trigger operation on the second commenting prompt tag is detected, starting the second commenting window.

S313, loading and displaying the second commenting data into the second commenting window.

The step specifically includes:

grouping the corresponding product grade information, product advantage information, product shortcoming information, and product evaluation links according to the sources information of the second commenting data;

sorting the product advantage information and the product shortcoming information in the grouping result according to their generating times; and

loading and displaying the grouped and sorted data into the second commenting window.

In the following example, the product object is an Apple mobile phone IPhone5s, the second commenting data come from website of Zhongguancun online, (www.zol.com.cn, ZOL), and process of loading and displaying a second commenting data in the second commenting window is described, see Table 1:

TABLE 1
Comprehensive Evaluation

| ZOL's Remark: ★★★★★5.0 Editor recommends | |
|---|---|
| Product's Advantages: Fingerprint distinguishing; 64-bit Apple | |
| A-7 processor and iSight lens | |
| Product's Shortcomings: High price, Outlook changed little | |
| Net Friends Remark: ★★★★⋆3.5 Recommended | |
| Advantages: | Shortcomings: |
| 1. Advantages obvious, | 1. Occasionally crash |
| system smooth | |
| 2. System smooth, good | 2. Ineffective battery |
| hand-feeling | |
| 3. Pretty outlook, delicate | 3. High price |

Evaluation: Internals better than externals IPhone5s complete
evaluation

### The Fourth Embodiment

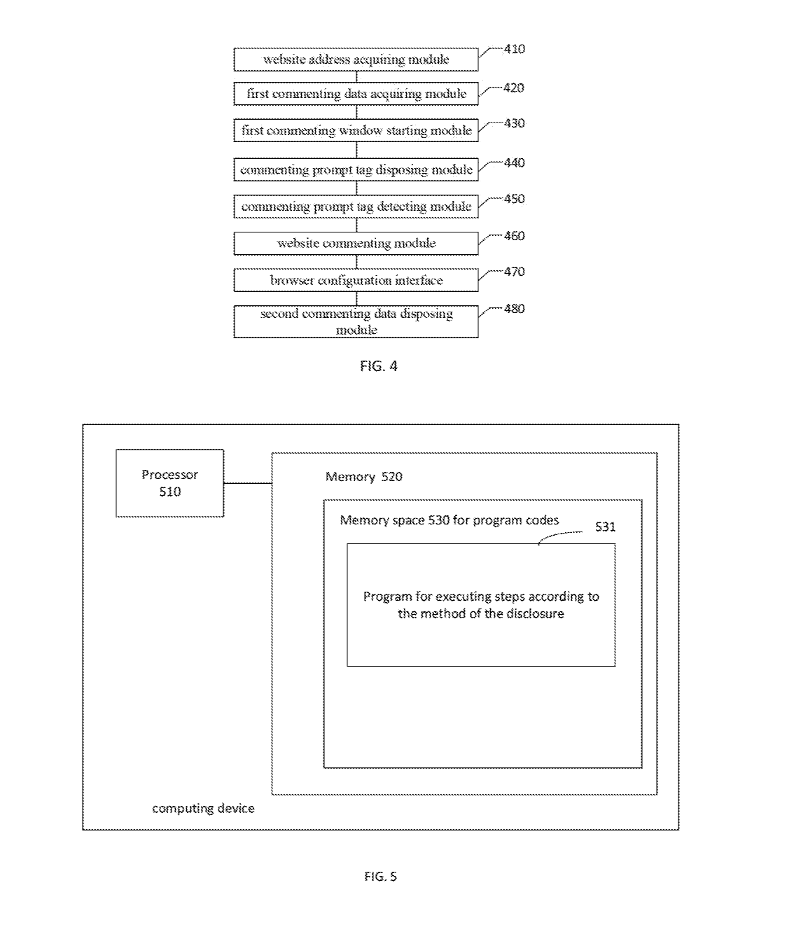

Referring to FIG. 4, it is a schematic diagram showing the structure of the browser client according to an embodiment of the invention The browser client including:

a website address acquiring module 410, configured to acquire webpage information corresponding to the currently loaded webpage;

a first commenting data acquiring module 420, configured to acquire first commenting data corresponding to the website address information from a server side according to the website address information acquired by the website address acquiring module;

a first commenting window starting module 430, configured to start a first commenting window, and load and display the first commenting data acquired by the first commenting data acquiring module into the first commenting window.

Wherein, the browser client further includes:

a commenting prompt tag disposing module 440, configured to disposed a commenting information prompt tag in the browser status bar; load and display commenting prompt information on the commenting information prompt tag according to the first commenting data; and the commenting prompt information includes: good-commenting rate and corresponding commenting icon;

the first commenting window starting module 430 is specifically configured to:

if a user's click operation on the commenting information prompt tag on the browser status bar is detected, start a first commenting window.

Wherein, the browser client further comprising:

a commenting prompt tag detecting module 450, configured to set the commenting information prompt tag on the browser status bar in inactivated status in gray color when it is determined the first commenting data acquired by the first commenting data acquiring module are invalid data.

Wherein, the first commenting data acquired by the first commenting data acquiring module 420 includes:

host computer name, and/or

good-commenting rate, and/or

total-commenting quantity, and/or

exposure quantity, and/or

good-commenting quantity, and/or

mid-commenting quantity, and/or

bad-commenting quantity, and/or

impression keyword, and/or

impression quantity.

Wherein, a commenting button and/or commenting webpage entry link is disposed in the first commenting window;

the browser client further includes:

a website commenting module 460, configured to load and display a corresponding website commenting page in the newly-started browser window if a user's click on the commenting button or the commenting webpage entry link in the first commenting window is detected; the website commenting page includes: user's impression keywords and corresponding impression quantity, user's commenting history information, a commenting information input frame and corresponding commenting information submitting button;

acquiring commenting information submitted by the user;

sending the acquired commenting information to the server side, and storing the commenting information as a first commenting data corresponding to the website address information of the currently loaded webpage.

Wherein, in the first commenting window is further disposed with a browser configuration entry button;

The browser client further includes:

a browser configuration interface 470, configured to load a browser configuration page in the newly-started browser window if it is determined that a user's click on the browser configuration entry button in the first commenting window is detected; the browser configuration page includes a commenting stating button; and receive the browser configuration information submitted by the user, the browser configuration information includes a commenting starting identification.

Wherein, the first commenting data acquiring module 420 is specifically configured to:

dispose a security query interface;

send security query requiring information to the server side via the security query interface, the security query requiring information carrying the website address information of the currently loaded webpage, and first commenting query requiring information;

receiving the security query result information from the server side, the security query result information carrying a first commenting data.

Wherein, the browser client further includes:

a second commenting data disposing module 480, configured to determine whether element in the currently loaded webpage includes a product object, if yes, acquire second commenting data corresponding to the product object from a server side;

starting a second commenting window in the browser side; and

loading and displaying the second commenting data into the second commenting window.

Wherein, the second commenting data acquired by the second commenting data disposing module specifically includes:

acquiring a second commenting data corresponding to the product object from a second commenting data interface in a server side; the second commenting data including: the source information of the second commenting data and the corresponding product grade information, and/or product advantage information, and/or product shortcoming information, and/or product evaluation link;

the second commenting data disposing module 480, is specifically configured to:

group the corresponding product grade information, product advantage information, product shortcoming information, and product evaluation link according to the second commenting data source information;

sort the product advantage information and the product shortcoming information in the grouping result according to their generating times; and

load and display the grouped and sorted data into the second commenting window.

Wherein, the second commenting data source information specifically includes: website of Zhongguancun online and website of Dianping.

Wherein, the website address information acquired from the website address acquiring module, specifically includes: webpage URL and host data of computer.

Algorithm and display provided herein are not inherently related to a particular computer, virtual system or other equipment. Various general systems may also be used with the teaching based on the disclosure. According to the above description, the required structure for constructing such a system is obvious. In addition, the disclosure is not directed to any particular programming language. It should be understood that a variety of programming languages can be used to implement the disclosed contents as described herein and above description to the particular programming language is to disclose the best inventive implementation mode.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the device in the embodiments can be adaptively modified and arranged in one or more devices different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

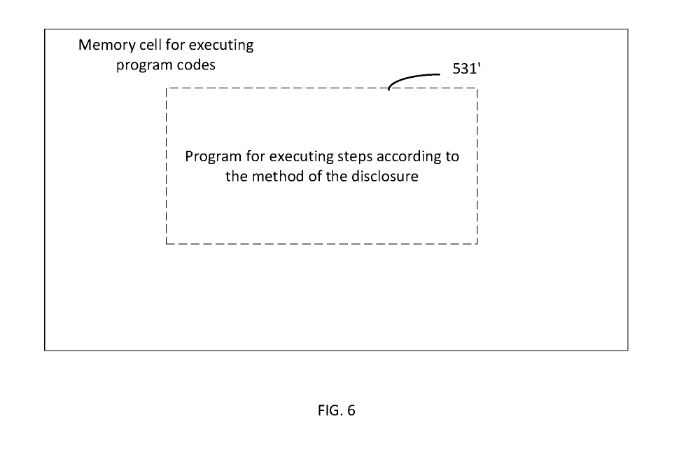

For example, FIG. 5 illustrates a block diagram of a computing device for executing the method according the disclosure. Traditionally, the computing device includes a processor 510 and a computer program product or a computer readable medium in form of a memory 520. The memory 520 could be electronic memories such as flash memory, EEPROM (Electrically Erasable Programmable Read—Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the computing device as shown in FIG. 5. The program codes may be compressed for example in an appropriate form. Usually, the memory cell includes computer readable codes 531′ which can be read for example by processors 510. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for loading website commenting information, comprising:
acquiring website address information corresponding to a currently loaded webpage;
acquiring first commenting data corresponding to the website address information from a server side according to the website address information of the currently loaded webpage; and
starting a first commenting window at a browser side, and loading and displaying the first commenting data in the first commenting window.

2. The method according to in claim 1, wherein before starting the first commenting window at the browser side, the method further comprises:
disposing a commenting information prompt tag on a browser status bar;
loading and displaying commenting prompt information on the commenting information prompt tag according to the first commenting data, the commenting prompt information comprising: good-commenting rate and corresponding commenting icon;
the starting the first commenting window at the browser side comprising:
if a user's click operation to the commenting information prompt tag on the browser status bar is detected, starting the first commenting window.

3. The method according to in claim 2, wherein the method further comprises:
if the first commenting data acquired from the server side according to the website address information of the currently loaded webpage are invalid data, setting the commenting information prompt tag on the browser status bar to be an inactivated status in gray color.

4. The method according to in claim 1, wherein, the first commenting data comprises at least one of:
host computer name,
good-commenting rate,
total-commenting quantity,
exposure quantity,
good-commenting quantity,
mid-commenting quantity,
bad-commenting quantity,
impression keyword, and
impression quantity.

5. The method according to in claim 1, wherein a commenting button or a commenting page entry link is disposed in the first commenting window;
the method further comprises:
if a user's click operation on the commenting button or the commenting page entry link in the first commenting window is detected, loading and displaying a corresponding website commenting page in a newly-started browser window; the website commenting page comprising:
a user's impression keyword and corresponding impression quantity, user's commenting history information, a commenting information input frame and a corresponding commenting information submitting button;
acquiring commenting information submitted by the user; and
sending the commenting information to the server side, and storing the commenting information as the first commenting data corresponding to the website address information of the currently loaded webpage.

6. The method according to in claim 5, wherein a browser configuration entry button is disposed in the first commenting window;
the method further comprising:
if a user's click on the browser configuration entry button in the first commenting window is detected, loading a browser configuration page in the newly-started browser window; the browser configuration page comprising commenting starting button; and
receiving browser configuration information submitted by the user, the browser configuration information comprising a commenting starting identification.

7. The method according to in claim 1, wherein the acquiring first commenting data corresponding to the website address information from a server side according to the website address information of the currently loaded webpage comprising:
disposing a security query interface at the browser side;
sending security query requesting information to the server side via the security query interface, the security query requesting information carrying the web site address information of the currently loaded webpage and first commenting query requesting information; and
receiving security query result information from the server side, the security query result information carrying the first commenting data.

8. The method according to in claim 1, wherein the method further comprises:
determining whether an element in the currently loaded webpage comprises a product object, if yes, acquiring second commenting data corresponding to the product object from the server side;
starting a second commenting window at the browser side; and
loading and displaying the second commenting data in the second commenting window.

9. The method according to in claim 8, wherein the acquiring second commenting data corresponding to the product object from the server side comprises:
acquiring second commenting data corresponding to the product object from a second commenting data interface at the server side; the second commenting data comprising at least one of: second commenting data source information and corresponding product grade information, product advantage information, product shortcoming information, and product evaluating link;
the loading and displaying the second commenting data in the second commenting window comprises:
grouping the corresponding product grade information, product advantage information, product shortcoming information and product evaluating link according to the second commenting data source information;
sorting the product advantage information and the product shortcoming information in the grouping result according to generating times of the product advantage information and the product shortcoming information; and
loading and displaying the grouped and sorted data in the second commenting window.

10.-11. (canceled)

12. A browser computing device, comprising:
a memory having instructions stored thereon;
a processor, configured to execute the instructions to perform operations for loading website commenting information, comprising:
acquiring website address information corresponding to a currently loaded webpage;
acquiring first commenting data corresponding to the website address information from a server side according to the website address information; and
starting a first commenting window at a browser side, and loading and displaying the first commenting data in the first commenting window.

13. The computing device according to claim 12, wherein, the processor is further configured to perform:
disposing a commenting information prompt tag on a browser status bar;
loading and displaying commenting prompt information on the commenting information prompt tag according to first commenting data, the commenting prompt information comprising: good-commenting rate and corresponding commenting icon; and
if a user's click operation on the commenting information prompt tag on the browser status bar is detected, starting the first commenting window.

14. The browser computing device according to claim 13, wherein, the processor is further configured to perform:
if it is determined the first commenting data acquired from the server side according to the website address information of the currently loaded webpage are invalid data, setting the commenting information prompt tag on the browser status bar to be an inactivated status in gray color.

15. The browser computing device according to claim 12, wherein the first commenting data comprises at least one of:
host computer name,
good-commenting rate,
total-commenting quantity,
exposure quantity,
good-commenting quantity,
mid-commenting quantity,
bad-commenting quantity,
impression keyword, and
impression quantity.

16. The computing device according to claim 12, wherein, a commenting button or a commenting page entry link is disposed in the first commenting window;
the processor is further configured to perform:
if it is determined a user's click operation on the commenting button or the commenting page entry link in the first commenting window is detected, loading and displaying a corresponding website commenting page in a newly-started browser window; the website commenting page comprising: a user's impression keyword and corresponding impression quantity, user's commenting history information, a commenting information input frame and a corresponding commenting information submit button;
acquiring commenting information submitted by the user; and
sending the acquired commenting information to the server side, and storing the commenting information as the first commenting data corresponding to the website address information of the currently loaded webpage.

17. The computing device according to claim 16, wherein a browser configuration entry button is further disposed in the first commenting window;
the processor is further configured to perform:
if it is determined a user's click on the browser configuration entry button in the first commenting window is detected, loading a browser configuration page in the newly-started browser window; the browser configuration page comprising commenting starting button; and
receiving browser configuration information submitted by the user, the browser configuration information comprising a commenting starting identification.

18. The computing device according to claim 12, wherein the processor is further configured to perform:
disposing a security query interface at the browser side;
sending security query requesting information to the server side via the security query interface, the security query requesting information carrying the web site address information of the currently loaded webpage and first commenting query requesting information; and
receiving security query result information from the server side, the security query result information carrying the first commenting data.

19. The computing device according to claim 12, wherein the processor is further configured to perform:
determining whether an element in the currently loaded webpage comprises a product object, if yes, acquiring second commenting data corresponding to the product object from the server side;
starting a second commenting window at the browser side; and
loading and displaying the second commenting data into that said second commenting window.

20. The computing device according to claim 19, wherein the processor is further configured to perform:
acquiring second commenting data corresponding to the product object from the second commenting data interface at the server side; the second commenting data comprising: second commenting data source information and corresponding product grade information, product advantage information, product shortcoming information, and product evaluating link;
the loading and displaying the second commenting data in the second commenting window comprises:
grouping the corresponding product grade information, product advantage information, product shortcoming information, and product evaluating link according to the second commenting data source information;
sorting the product advantage information and the product shortcoming information in the grouping result according to generating times of the product advantage information and the product shortcoming information; and
loading and displaying the grouped and sorted data in the second commenting window.

21. (canceled)

22. The computing device according to claim 12, wherein the website address information corresponding to the currently loaded webpage comprising: webpage URL and host data.

23. (canceled)

24. A computer readable medium, having computer programs stored thereon that, when executed by one or more processors of a computing device, cause the computing device to perform:
acquiring website address information corresponding to a currently loaded webpage;
acquiring first commenting data corresponding to the website address information from a server side according to the website address information of the currently loaded webpage; and
starting a first commenting window at a browser side, and loading and displaying the first commenting data in the first commenting window.
